(19) United States
(12) Patent Application Publication
(10) Pub. No.: US 2013/0209657 A1
(43) Pub. Date: Aug. 15, 2013

(54) METHOD FOR MAKING ANIMAL FEED FROM LIGNOCELLULOSIC BIOMASS

(71) Applicant: Kenneth Hillel Peter Harris, Asker (NO)

(72) Inventor: Kenneth Hillel Peter Harris, Asker (NO)

(21) Appl. No.: 13/702,910

(22) PCT Filed: Jun. 8, 2011
(86) PCT No.: PCT/IB11/01962

§ 371 Date: Jan. 14, 2013

Related U.S. Application Data
(60) Provisional application No. 61/352,579, filed on Jun. 8, 2010.

(51) Int. Cl. A23K 1/14

(52) U.S. Cl. CPC A23K 1/14
USPC 426/648; 426/511

(57) ABSTRACT

The present invention provides a method of making animal feed from lignocellulosic biomass. Biomass material having a moisture content of less than 30% is introduced into a pressure vessel. A vacuum is applied to the pressure vessel for at least one and preferably two minutes. Then steam is introduced to heat the biomass material to a temperature range of between about 180° C. and 235° C. where it is maintained for from 1 to 12 minutes before reducing the pressure in the vessel. In particularly preferred embodiments, the moisture content is below 15%, the temperature range is from 190° C. to 215° C. and the residence time is from 2 to 8 minutes.

### CROSS REFERENCE TO RELATED APPLICATIONS

This application claims the benefit under 35 U.S.C. §119(e) of U.S. Provisional Application No. 61/352,579, filed Jun. 8, 2010, which is hereby expressly incorporated herein by reference in its entirety.

### FIELD OF THE INVENTION

The present invention relates, in general, to a cost and energy efficient method of converting inedible lignocellulosic materials to substances that can be used to manufacture animal feed and replace food crops such as cereals and soybeans.

### BACKGROUND OF THE INVENTION

High oil prices and the increasing use of grain in making ethanol for fuel, has pushed up the price of the cereal and protein components in animal feed and has also increased world food prices. There is, therefore, a worldwide interest in replacing these commodities with other renewable resources, such as wood, low quality grasses and organic wastes, that have not been traditionally used as foodstuffs.

One problem with such an approach is that lignocellulosic biomasses like hardwood and bagasse have low digestibility for animals, and there are few established procedures for processing such resources to increase the assimilability. There is, however, fairly widespread agreement that a successful technique requires that the lignin be detached from the cellulose fiber bundles and that these, if possible be broken down to individual fibrils. Two such methods entail the use of acid hydrolysis, either by cooking the biomass in water to which acid has been added or by pre-impregnating the biomass with an acid, typically sulphuric acid, and then subjecting the whole to medium pressure steam, following the precepts of the so-called steam explosion process. In both cases, the result is a partially hydrolyzed biomass consisting of hemicellulose-derived sugars and a more assimilable cellulose.

However, this procedure is not without its difficulties, the main ones being the concomitant production of substances such as furfural that can prove toxic to microorganisms in the animal gut and the attainment of a sufficiently high degree of digestibility. There is also the question of the cost and complexity of the plant needed to manufacture the product in this manner, further complicated by the fact that in most cases the prior art recommends the use of acid catalysts.

The method of the present invention allows woody and other biomass resources to be converted to substances of high digestibility for ruminants and, thus, useful for making fully formulated feed and feed pellets.

### SUMMARY OF THE INVENTION

Accordingly, the present invention provides a method of making animal feed from lignocellulosic biomass that includes the steps of: (a) introducing biomass material having a moisture content of less than 30% to a pressure vessel; (b) applying a vacuum to the pressure vessel for at least one minute; (c) introducing steam into the pressure vessel to heat the material to a temperature range between about 180° C. and 235° C.; (d) maintaining the temperature of material within the temperature range for from 1 to 12 minutes; and (e) reducing the pressure in the pressure vessel. A catalyst may optionally be introduced into the pressure vessel immediately prior to or together with the steam. In particularly preferred embodiments, the temperature range is from 190° C. to 215° C. and the residence time is from 2 to 8 minutes.

### DESCRIPTION OF THE PREFERRED EMBODIMENTS

In accordance with a preferred embodiment of the present invention, a lignocellulosic biomass is converted to an animal feed with high digestibility. The lignocellulosic biomass, can be any suitable lignocellulosic resource, preferably hardwood or an annual crop residue, like bagasse. The biomass should be chipped or otherwise reduced in size so that its smallest dimension is less than about 25 mm, preferably about 5-10 mm. For best results, the biomass should have a bulk density of at least 200 kg/m³, preferably between 450 and 500 kg/m³. This can be achieved by compressing material of lower bulk density in a pellet mill or similar device.

If necessary, the biomass is dried to a moisture content of less than 30%, and most preferably to 15% or less. Such drying can be achieved by any suitable means, such as, for example, in a drum dryer. Once dried, the biomass is introduced, preferably while still warm, into a hot pressure vessel equipped in such a manner that a vacuum can be drawn, preferably from the top, and steam and any other desired chemicals can be introduced at the base.

Once the biomass is inside, the pressure vessel is closed and then a vacuum of not more than 500 torr and preferably less than 300 torr is applied for a period of at least one and preferably two minutes. Next, steam is introduced into the pressure vessel to raise the temperature of the biomass to between 185° C. and 225° C. and held in that range for from 2 to 12 minutes. In particularly preferred embodiments, the temperature range is from 190° C. to 215° C. and the residence time is from 2 to 8 minutes.

The steam is then transferred to a steam reservoir, and compressed air is used to blow the steam treated biomass from the pressure vessel. Alternatively, the treated biomass and steam can be blown out together by simply venting the pressure vessel.

The steam processed materials described here can be used directly as fodder for ruminants, preferably after their pH has been adjusted to 7-8 by the addition of an alkaline substance such as powdered limestone, or by kneading with calcium hydroxide or finely divided calcium carbonate. However they do not contain sufficient protein-nitrogen or essential minerals to function as a complete feed, and these need to be added if the product is to serve this purpose.

In another embodiment, 1-8% on weight of biomass of a catalyst whose function is to increase the detachment of lignin from the cellulose fibers, such as sulfur dioxide, hydrogen peroxide or a vegetable oil can be introduced immediately prior to or together with the steam. Use of a catalyst will allow the treatment pressure and residence time to be reduced.

The steam pressure may be released suddenly, which is the so-called “steam explosion” technique. However, no chemical change is apparent, as measured by the content of water and alkali soluble components in the biomass steam treated in the manner described herein when the pressure is released more slowly, i.e. without “explosion”. This is in complete contrast to conventional teaching and is valuable inasmuch as it permits more of the steam energy to be recovered.

Where lightweight materials such as grass or annual crop residues are used as raw material, it is advantageous to compress these loosely, e.g. to pellets having a bulk density of 450-500 kg/m³ in order to minimize the steam requirement per ton biomass.

It is a specific advantage for the method of this technology that the lignin is detached from the cellulose and where sulphur dioxide is used as catalyst, becomes soluble in water at a pH greater than 3 and can subsequently function as a water soluble binder.

This is especially useful if the biomass is subsequently used as feed pellets following the addition of other components such as urea, proteins, oils, minerals, etc., to make a fully compounded animal feed. Binders such as these have been shown to exercise a positive effect on the stability of proteins in the rumen.

Another specific advantage for this method is that processing in the preferred range of 190-215° C. leads to a partial hydrolysis of the cellulose fibers, reducing their average degree of polymerization and making them more accessible for bacterial hydrolysis in the rumen and, thus, increasing the digestibility of the feed. Using higher temperatures may risk an increase in furfural content.

A particular advantage of the present method is that it treats lignocellulosic biomass with medium pressure steam in such a way that the lignin and hemicellulose components, together with any extractibles (resins, etc.), are hydrolyzed such that they dissolve in one another, forming a melt that can account for as much as 50% or more of the biomass. This allows for a more complete detachment of the lignin polymer from the cellulose fiber bundles, while accelerating its subsequent hydrolysis which improves the microbial conversion of the biomass in the rumen or by cellulolytic organisms.

Use of vacuum both dries the biomass fully to provide the correct conditions for hydrolysis (or perhaps solvolysis) and removes interstitial air, so that all parts of the biomass are treated equally when the steam is introduced, thereby ensuring that hydrolysis proceeds similarly throughout the biomass.

Evacuation of the reactor before the introduction of steam leads to biomass after steam treatment that has a different chemical composition in terms of its solubility in water and alkali and in its content of volatile organic matter such as furfurals; this is most unexpected according to conventional wisdom and can only result from the drying action of the vacuum having altered the kinetics of the hydrolysis process.

Another benefit of evacuating the reactor is that interstitial air is removed from the feed particles ensuring a more rapid and homogeneous heating of the whole, which can be a problem with conventional steam explosion methods. This permits larger feed particles such as woodchips and even compacted pellets e.g. of grass to be used whilst at the same time eliminating the need for energy and capital intensive hammer-mills or other size reduction equipment.

The use of compacted material has the further advantage of reducing the amount of steam required per unit of production, because the void volume in the reactor is less due to the compacted material's higher bulk density. This is only possible when vacuum pre-treatment is employed to remove interstitial air and enable steam to penetrate the whole of the biomass uniformly. These benefits can reduce the steam required per unit weight of biomass dry matter by as much as 25%.

When used with lignocellulosic biomass, the low moisture levels in the reactor employed by the method described here have the effect of converting the hemicellulose, lignin and resinous components of the biomass into a mixed solution, removing them from association with the cellulose fibers and at the same time increasing their availability for microbial attack in the animal gut. Furthermore, the specific conditions employed here.

The soluble carbohydrates in the steam treated material also allow low cost nitrogen compounds such as urea, to be rapidly converted by microbes to assimilable to protein. Without these readily available carbon sources, urea would be converted to ammonia and the animal would suffer from ammonia poisoning.

Furthermore, the degree of delignification achieved by the method of this invention produces a cellulose whose microbial susceptibility approaches that which is otherwise only achieved by bleaching.

### EXAMPLE 1

Table 1 below shows typical digestibilities for the holocellulose content of hardwoods processed by this method are 70-80% compared to 30-40% in the natural state; for grasses such as switchgrass, not considered as suitable cattle fodder, this increases to as much as 85%.

| | | Residual | CaCO₃ soluble | Furfural | In vitro |
|---|---|---|---|---|---|
| Feedstock | Method | Lignin, %⁶ | lignin, % | content, % | digestibility, %⁷ |
| A. Aspenwood¹ | | 23.5 | <1 | 0 | 30 |
| B. Aspenwood¹ | No vacuum or SO₂³ | 8.3 | 2.8 | 1.9 | 55 |
| C. Aspenwood¹ | Vacuum only⁴ | 5.8 | 3.1 | 1.3 | 71 |
| D. Aspenwood¹ | 2% SO₂ only³ | 4.6 | 6.9 | 1.7 | 65 |
| E. Aspenwood¹ | Vacuum + 2% SO₂⁵ | 3.8 | 8.1 | 0.3 | 81 |
| F. Switchgrass² | | 19.0 | <1 | 0 | 41 |
| G. Switchgrass² | No vacuum or SO₂³ | 7.2 | 1.9 | 1.9 | 57 |
| H. Switchgrass² | Vacuum only⁴ | 5.2 | 2.4 | 1.4 | 80 |
| I. Switchgrass² | 1% SO₂ only³ | 4.7 | 5.7 | 1.6 | 70 |
| J. Switchgrass² | Vacuum + 1% SO₂⁵ | 3.2 | 7.3 | 1.1 | 83 |

¹Chips, smallest dimension 10 mm
²Pellets, 20 × 8 mm bulk density 500 kg/m³
³260 psig saturated steam, 5 mins. residence time
⁴80% vacuum for 1 minute, 260 psig saturated steam, 4 mins. residence time
⁵80% vacuum for 1 minute, 260 psig saturated steam, 3 mins. residence time
⁶6 x kappa number after alkali wash
⁷Of holocellulose component in raw material

### EXAMPLE 2

It is a specific advantage of the method of this invention that the water soluble aliphatic components, primarily organic acids and carbohydrates formed by hydrolysis function as a readily available carbon sources for the microbial conversion in the animal gut of low cost nitrogen compounds such as urea to proteinaceous compounds that can be assimilated by the animal. This allows expensive protein meal often used in animal feed, e.g. soybean meal, to be replaced completely. Similarly, the high digestibility of the steam treated biomass enables it to completely replace expensive energy-rich components such as corn, often fed to ruminants.

This is illustrated in Table 2 below, in which various feeds are compared having the same properties as the recommended feed for ruminants:

| | | | | | | ST switchgrass, |
|---|---|---|---|---|---|---|
| Component as | Digest- | Soluble | Nitrogen | Standard | Corn, hay, | switchgrass urea |
| 100% dry matter | ibility | sugars | content | feed^{ref} | molasses, urea⁵ | molasses |
| Corn (maize) | 91.0% | 3.0% | 1.5% | 51.0% | 45.5% | 0 |
| Soy meal | 96.0% | 2.0% | 7.0% | 8.0% | 0 | 0 |
| Alfalfa hay silage | 63.0% | 3.0% | 3.0% | 41.0% | 43.0% | 0 |
| Switchgrass¹ | 30.0% | 1.0% | 1.20% | 0.0% | 0 | 6.1% |
| ST switchgrass² | 80.0% | 40.0% | 0.7% | 0 | 0 | 78.2% |
| Sum soluble | | | | 2.9% | 2.7% | 37.3% |
| sugars³ | | | | | | |
| Molasses⁴ | 99.0% | 90.0% | 0.50% | 0 | 70.2% | 77.5% |
| Urea | 10.,0% | 0.0% | 46.0% | 0 | 7.3% | 4.2% |
| SUM | | | | 100.0% | 100.0% | 100.0% |
| Total N, % | | | | 2.6% | 2.6% | 2.6% |
| Digestibilty, % | | | | 79.9% | 79.9% | 79.9% |
| Roughage, % | | | | 20.7% | 20.7% | 20.7% |

¹Added to maintain roughage content
²Steam treated as per method H in section G.
³From above plant materials
⁴Added to ensure sufficient soluble sugar content for microbial conversion of all urea to protein
⁵Example of feed mix made in situ with urea

The feed based upon steam treated switchgrass not only replaces corn and soy bean meal but also protein rich materials such as alfalfa silage. Unlike switchgrass, alfalfa is susceptible to a number of diseases, can only be raised in well-watered areas and is a relatively expensive crop to grow. Furthermore, switchgrass raised for treatment by the method described here does not require the use of herbicides as the process will also convert weed species to high value fodder.

Animal feed compositions made from biomass processed in accordance with one embodiment of the present invention will contain a water soluble, nitrogen-rich compound, preferably urea, in the ratio of 1 part by weight of nitrogen thus contained to between 18 and 25 parts by weight of the water soluble components of the biomass.

From the present description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed herein.

What is claimed:

1. A process for making animal feed from a lignocellulosic biomass material, comprising the steps of:
(a) introducing biomass material having a moisture content of less than 30% to a pressure vessel;
(b) applying a vacuum to the pressure vessel for at least one minute;
(c) introducing steam into the pressure vessel to heat the material to a temperature range between about 190° C. and 225° C.;
(d) maintaining the temperature of material within the temperature range for from 1 to 12 minutes; and
(e) reducing the pressure in the pressure vessel.

2. The process of claim 1 wherein the moisture content of the biomass material introduced into the pressure vessel is less than 15%.

3. The process of claim 2 wherein the temperature range is from 190° C. to 215° C.

4. The process of claim 3 wherein the temperature of the material is maintained within the temperature range for from two to eight minutes.

5. The process of claim 1 further comprising the step of introducing from one to eight percent by weight of biomass of a catalyst prior to or with the introduction of steam into the pressure vessel.

6. The process of claim 5 wherein the catalyst is selected from the group consisting of sulfur dioxide, hydrogen peroxide and vegetable oil.

7. An animal feed composition made from biomass processed according to claim 1 containing a water soluble, nitrogen-rich compound, preferably urea, in the ratio of 1 part by weight of nitrogen thus contained to between 18 and 25 parts by weight of the water soluble aliphatic components of the biomass.
